(19) United States
(12) Patent Application Publication
(10) Pub. No.: US 2017/0093751 A1
(43) Pub. Date: Mar. 30, 2017

(54) NODE, MASTER DEVICE, AND COMMUNICATION CONTROL SYSTEM, METHOD, AND PROGRAM

(71) Applicant: NEC Corporation, Tokyo (JP)

(72) Inventors: Tomonori ISHIDA, Tokyo (JP); Hiroslhi NAKAISHI, Tokyo (JP)

(21) Appl. No.: 15/309,096

(22) PCT Filed: May 1, 2016
(86) PCT No.: PCT/JP2015/002306

§ 371 Date: Nov. 4, 2016

(30) Foreign Application Priority Data
May 7, 2014 (JP) 2014-095960

(51) Int. Cl. H04L 12/927; H04Q 9/00; H04L 12/801; H04L 12/851

(52) U.S. Cl. CPC H04L 47/805; H04L 47/24; H04Q 9/00; H04L 47/14; H04Q 2209/60; H04Q 2209/10; H04Q 2209/40

(57) ABSTRACT

A communication control system includes a plurality of nodes 31, and a master device 30 for performing flow control of multihop communication in a network including the plurality of nodes 31. The master device 30 allocates, to each of the nodes, a time obtained by subtracting, from a frame period, a total one frame transmission time of each node, used for first service, as a one frame transmission time used for second service having a priority set lower than that of the first service.

### TECHNICAL FIELD

The present invention relates to a node, a master device, and a communication control system, a method, and a program which are used for multihop communication.

### BACKGROUND ART

For example, in many cases, a main object of multihop communication is to provide single service such as advanced metering infrastructure (AMI) service. However, when a communication system such as long term evolution (LTE) is used for band extension, a communication control system using multihop communication is expected to be used for additional service (video distribution, Internet browsing, or the like). At that time, a technique is required which allows effective and fair use of unoccupied band while accurately securing a band for the AMI service as the main object.

For example, a communication control system including a master communication terminal and slave communication terminals are described in PTL 1. In PTL 1, the master communication terminal includes a contention management table registering communication-terminal transmission order, and receives participation requests from the slave communication terminals for participation of the slave communication terminals in a network.

Furthermore, PTL 2 describes that wireless communication devices constituting a wireless ad-hoc network recognize participation of a new node in the ad-hoc network. PTL2 further describes that nodes each measure a usage condition of a radio band in a communication range, change a beacon transmission interval when the radio band usage rate is not less than a certain value, and inhibit increase in band used for wireless communication or packet collision rate, caused by beacon.

A system including a premises communication adapter and a wide area communication adapter connected to the premises communication adapter is described in PTL 3. PTL 3 also describes that the wide area communication adapter uses a wireless LAN communication function to transmit and receive signals to and from a gas management server provided in a data center or the like of a gas company. Furthermore, PTL 3 describes that, for communication between premises communication adapters, multistage relay transmission is performed, which is known as multihop transmission.

### CITATION LIST

### Patent Literature

PTL 1: Japanese Patent Application Laid-Open No. 2004-363702 (paragraph 0012)

PTL 2: Japanese Patent Application Laid-Open No. 2006-287463 (paragraphs 0032, 0036)

PTL 3: International Unexamined Patent Application No. 2013/062101 (paragraphs 0222, 0227, 0235)

### SUMMARY OF INVENTION

### Technical Problem

However, in the communication control systems described in PTLS 1 to 3, when a large number of nodes transmit participation requests to a master terminal, enough communication band sometimes cannot be secured. For example, PTL 2 describes the inhibition of increase in band used for wireless communication or packet collision rate, caused by beacon is described, but does not describe securing a communication band for packet communication used for service. When a plurality of services is provided to the slave communication terminals, band allocation is not performed according to the services. Accordingly, for example, the slave terminals may use low-priority additional service to transmit high-priority data such as electric meter reading in the AMI service, and cause insufficient communication band.

Therefore, an object of the present invention is to provide a node, a master device, and a communication control system, method, and program with which a band for communication of high-priority data transmitted from a node participating in a multihop communication network is preferentially secured.

### SOLUTION TO PROBLEM

A node according to the present invention is included in a communication control system which comprises a plurality of nodes and a master device for performing flow control of multihop communication in a network including the nodes. A time obtained by subtracting, from a frame period, a total one frame transmission time of each node, used for first service, is allocated to the node as a one frame transmission time used for second service having a priority set lower than that of the first service.

A master device according to the present invention is a master device performing flow control of multihop communication in a network including a plurality of nodes, and the master device allocates, to each of the nodes, a time obtained by subtracting, from a frame period, a total one frame transmission time of each node, used for first service, as a one frame transmission time used for second service having a priority set lower than that of the first service.

A communication control system according to the present invention is a communication control system including a plurality of nodes, and a master device for performing flow control of multihop communication in a network including the nodes, and the master device allocates, to each of the nodes, a time obtained by subtracting, from a frame period, a total one frame transmission time of each node, used for first service, as a one frame transmission time used for second service having a priority set lower than that of the first service.

A communication control method according to the present invention is a communication control method used for a plurality of nodes, and a master device for performing flow control of multihop communication in a network including the nodes, and the master device allocates, to each of the nodes, a time obtained by subtracting, from a frame period, a total one frame transmission time of each node, used for first service, as a one frame transmission time used for second service having a priority set lower than that of the first service.

A communication control program according to the present invention is a communication control program installed in a computer for performing flow control of multihop communication in a network including a plurality of nodes, and the communication control program causes the computer to allocate, to each of the nodes, a time obtained by subtracting, from a frame period, a total one frame transmission time of each node, used for first service, as a one frame transmission time used for second service having a priority set lower than that of the first service.

### ADVANTAGEOUS EFFECTS OF INVENTION

According to the present invention, a band for communication of high-priority data transmitted from a node participating in a multihop communication network is preferentially secured.

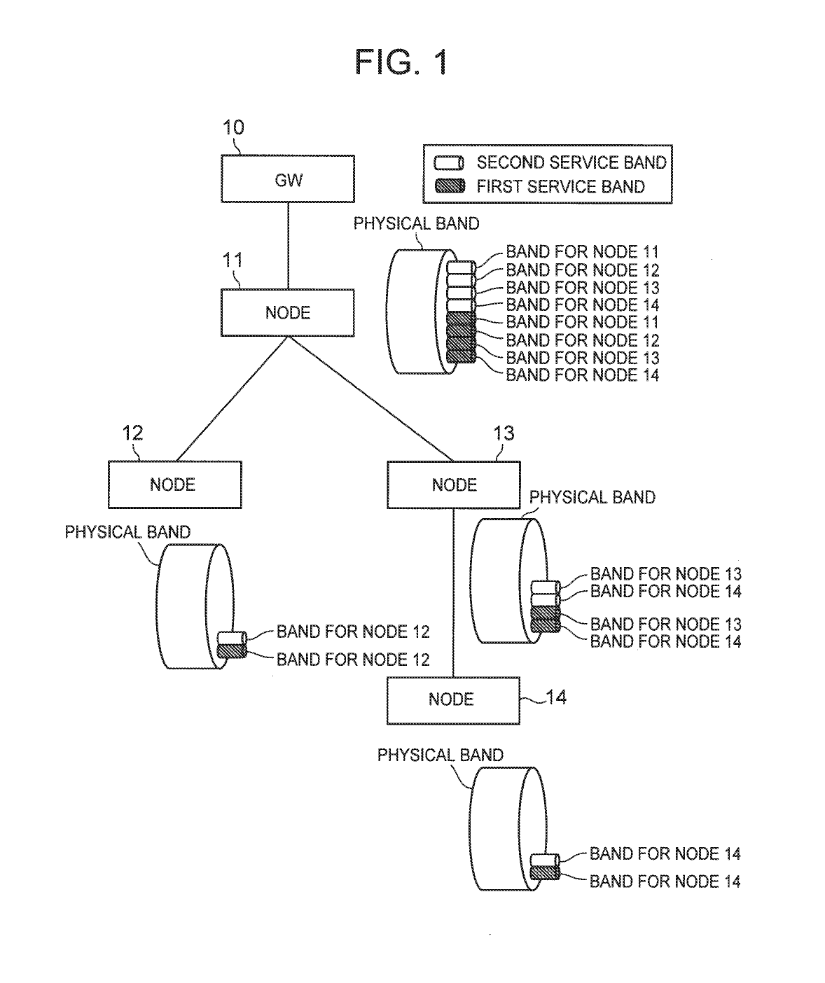

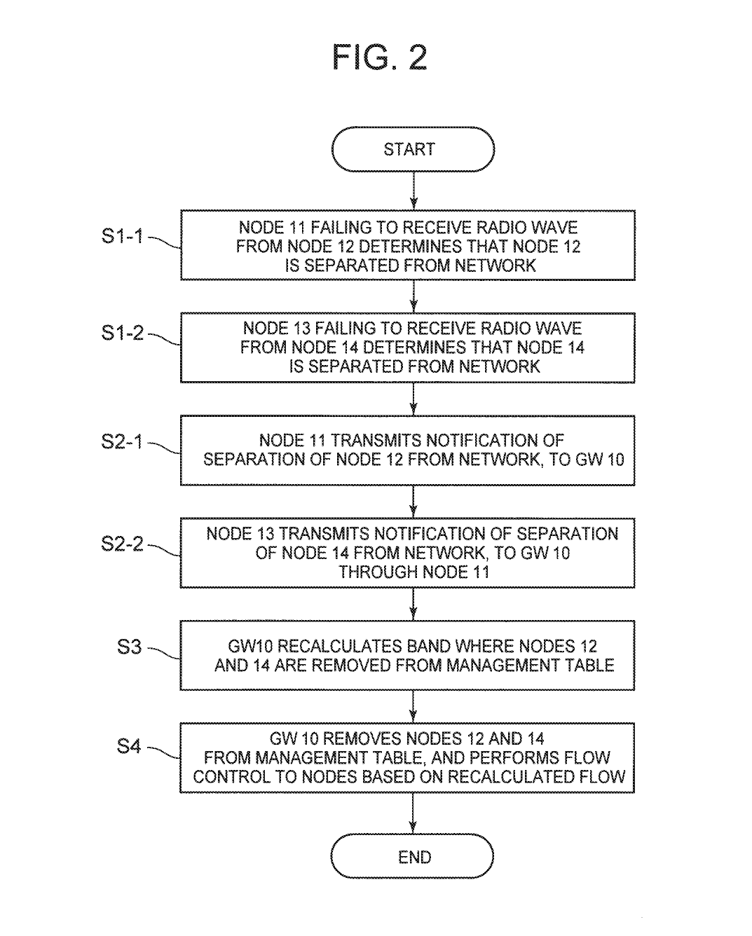

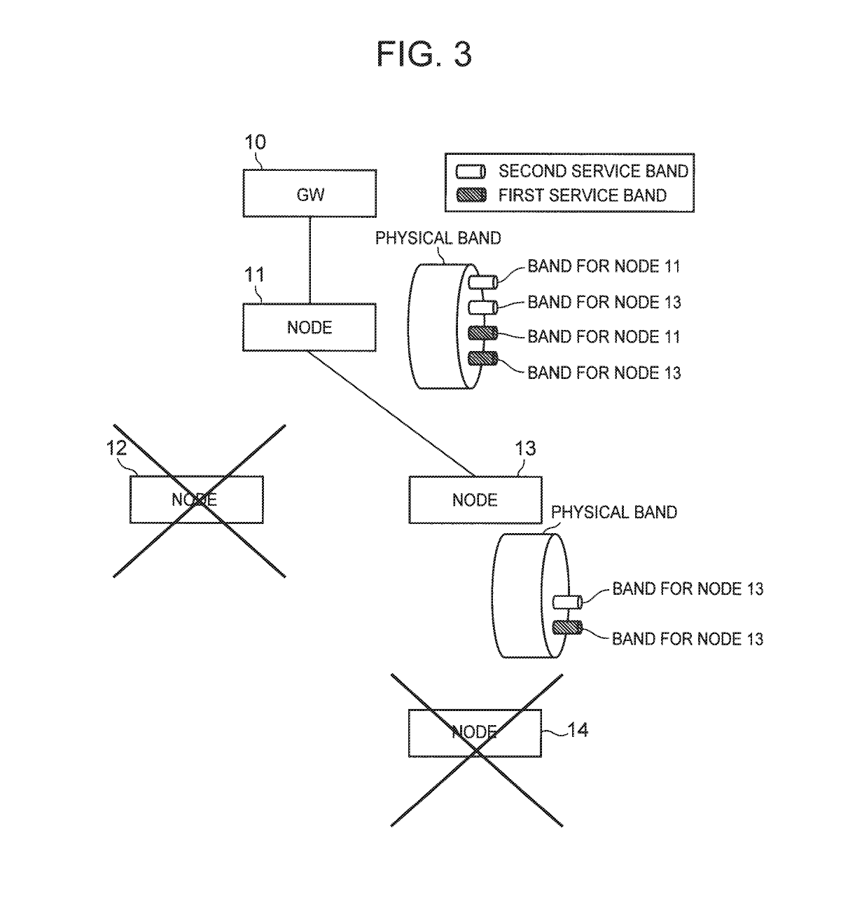

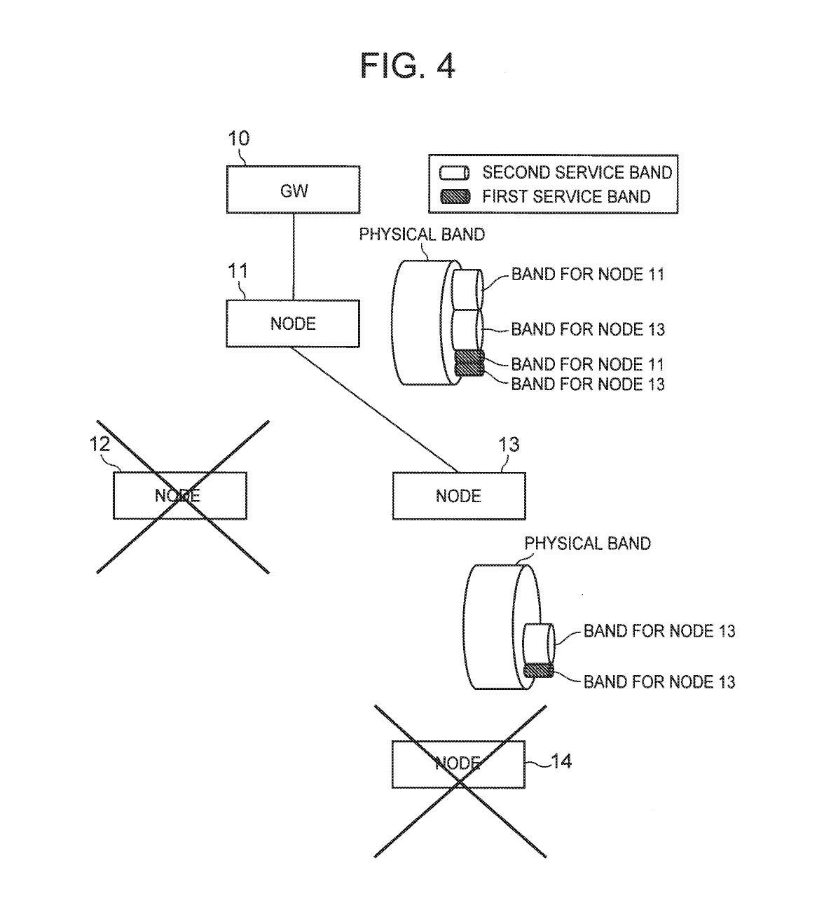

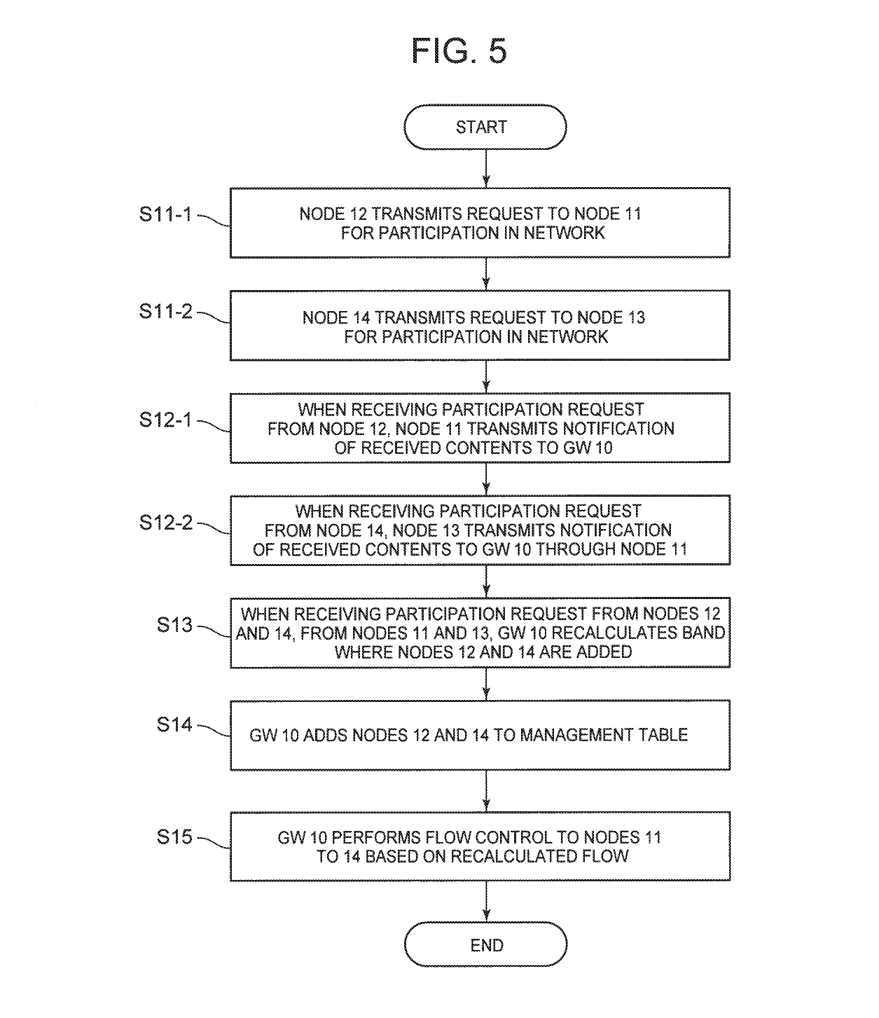

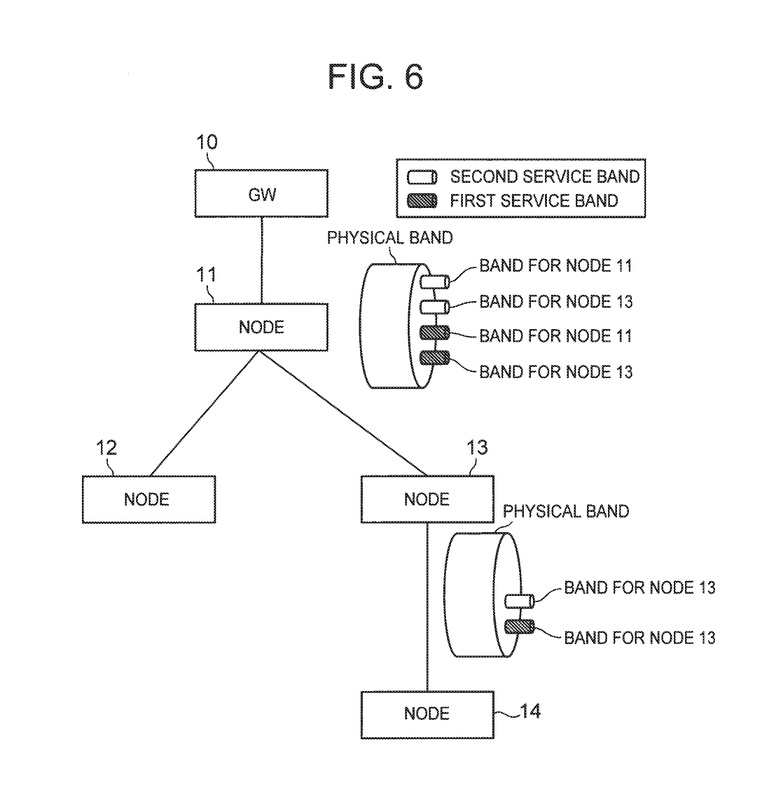

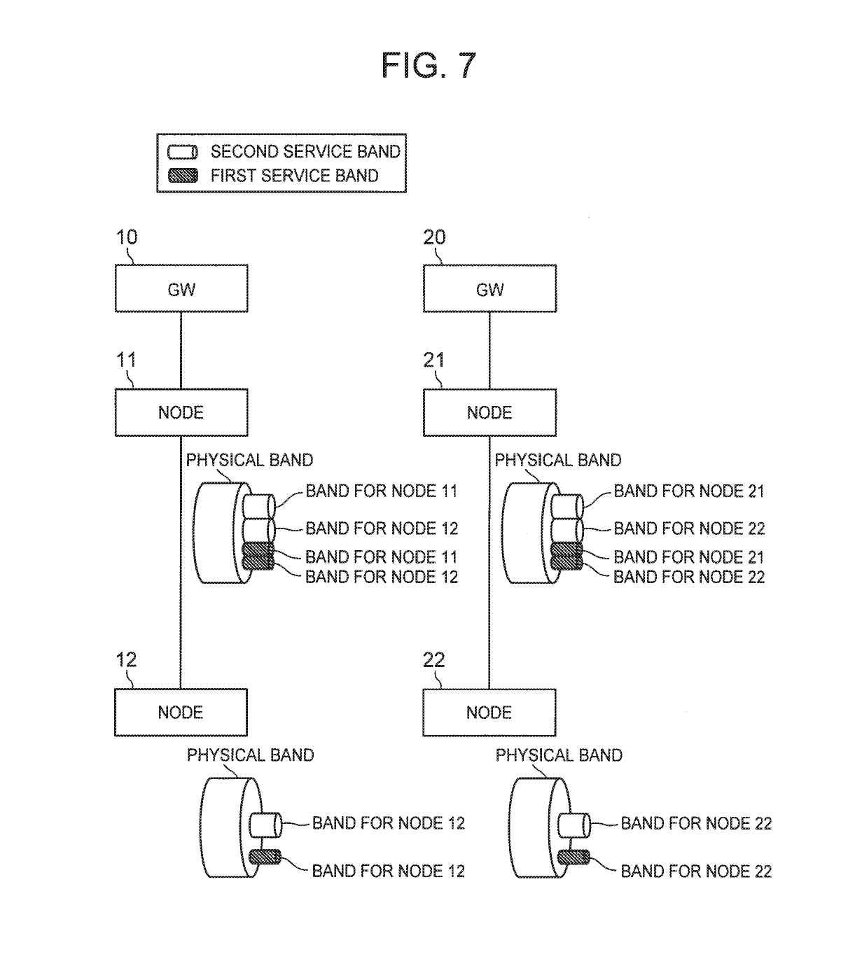

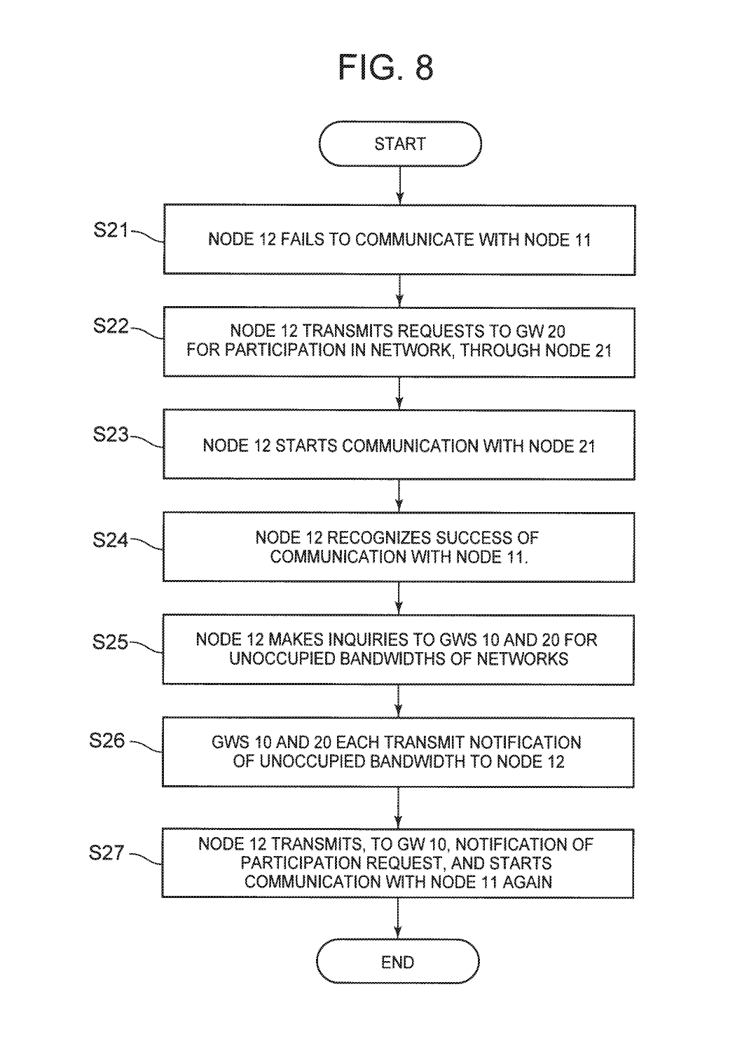

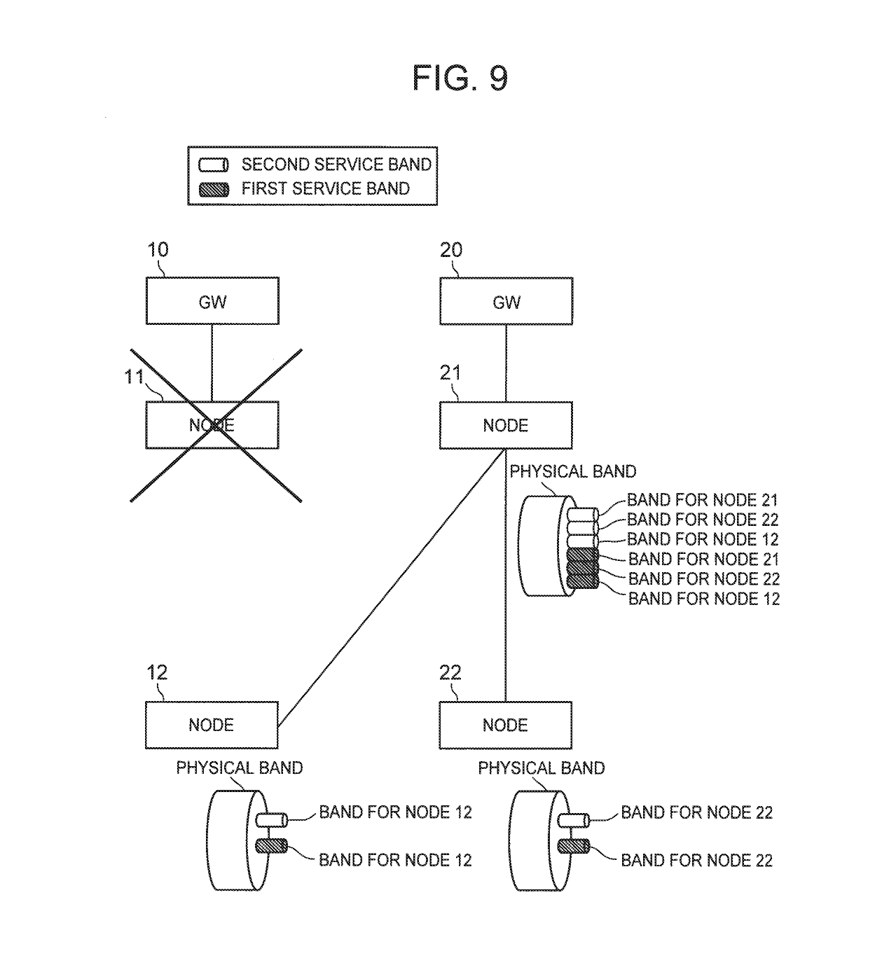

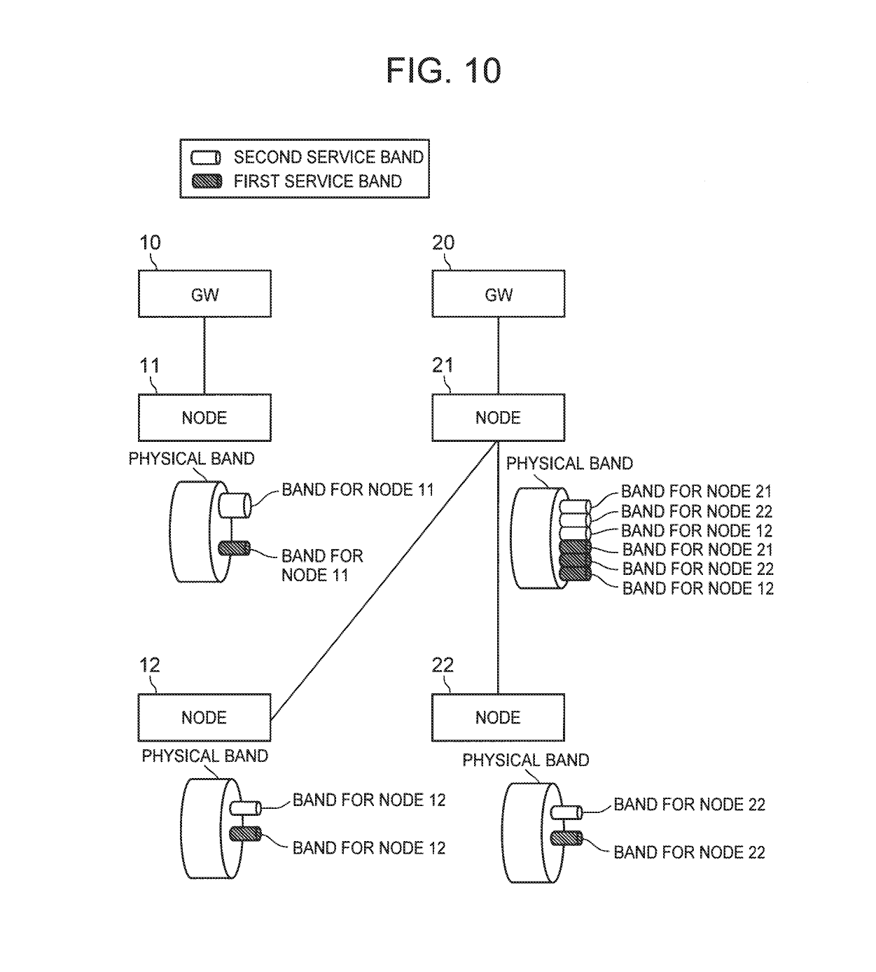

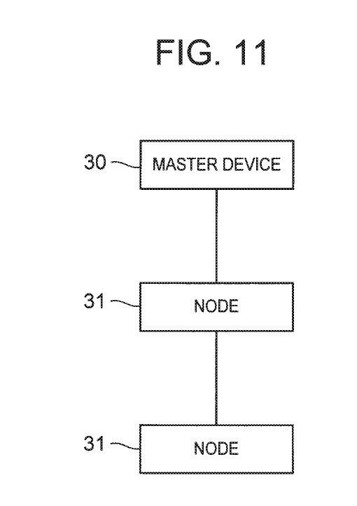

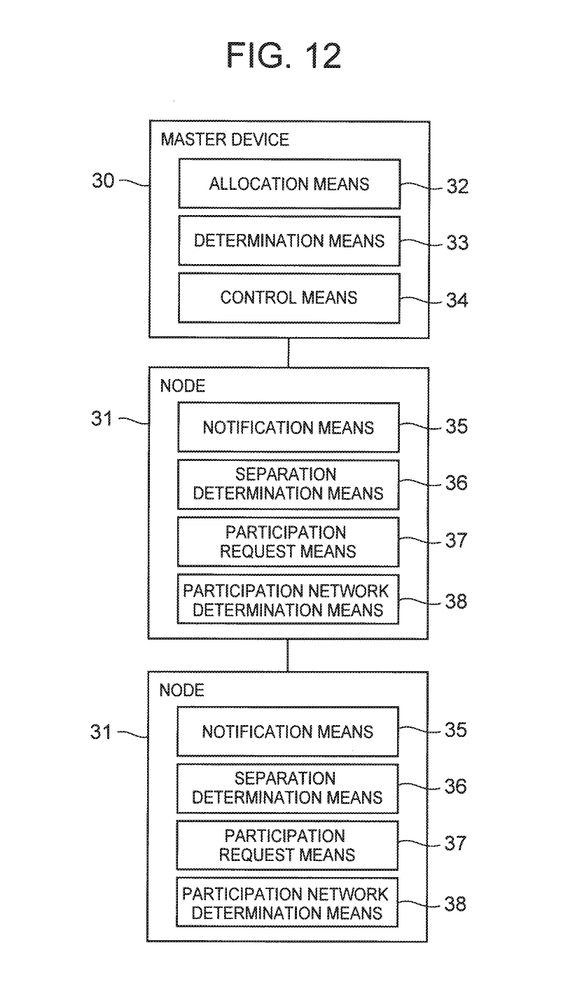

### BRIEF DESCRIPTION OF DRAWINGS

[FIG. 1] It depicts an explanatory diagram illustrating a configuration of a communication control system according to a first exemplary embodiment.

[FIG. 2] It depicts a flowchart illustrating operation which is performed when some of nodes are separated from the network.

[FIG. 3] It depicts an explanatory diagram illustrating a state of the network from which some of the nodes are separated.

[FIG. 4] It depicts an explanatory diagram illustrating a state of the network after performance of flow control based on recalculated bandwidth.

[FIG. 5] It depicts a flowchart illustrating operation which is performed when the separated nodes request participation in the network again.

[FIG. 6] It depicts an explanatory diagram illustrating a state of the network where second service band is returned to previous band.

[FIG. 7] It depicts an explanatory diagram illustrating a configuration of a communication control system according to a second exemplary embodiment.

[FIG. 8] It depicts a flowchart illustrating operation of the communication control system according to the second exemplary embodiment.

[FIG. 9] It depicts an explanatory diagram illustrating a state of networks in which any of nodes participates in another network.

[FIG. 10] It depicts an explanatory diagram illustrating a state of networks when the separated node is returned.

[FIG. 11] It depicts a block diagram illustrating a configuration of a main portion of the communication control system according to the present invention.

[FIG. 12] It depicts a block diagram illustrating a specific configuration of the main portion of the communication control system according to the present invention.

### DESCRIPTION OF EMBODIMENTS

### Exemplary Embodiment 1

A first exemplary embodiment (exemplary embodiment 1) according to the present invention will be described below with reference to the drawings. FIG. 1 is an explanatory diagram illustrating a configuration of a communication control system according to the present exemplary embodiment. As illustrated in FIG. 1, the communication control system according to the present exemplary embodiment includes a gateway (GW) 10, and nodes 11 to 14 controlled by the GW 10. Note that, the GW 10 corresponds to a master device in the present invention. In the communication control system illustrated in FIG. 1, the GW 10 is allowed to communicate only with the node 11, but the GW 10 may be allowed to communicate with at least two nodes. Furthermore, in FIG. 1, the communication control system has a tree network topology, but for example may have a mesh network topology. Furthermore, four nodes are exemplified in FIG. 1, but the number of nodes is not particularly limited. For communication among the nodes 11 to 14, multihop communication is used.

Functions of the GW 10 and the nodes 11 to 14 are for example achieved by hardware designed to perform specific calculation processing or the like, or an information processing device such as a central processing unit (CPU) operated according to a program. Furthermore, the program is stored in a non-transitory computer-readable storage medium.

The GW 10 controls multihop communication of a network including the nodes 11 to 14. The GW 10 is for example a commonly-used gateway device for connecting a network to another network having a different protocol. The GW 10 holds a management table in which nodes participating in a network are recorded. The GW 10 holds a management table shown in table 1 as a management table corresponding to the network topology illustrated in FIG. 1.

TABLE 11
Network participating node
Node 11
Node 12
Node 13
Node 14

Furthermore, the GW 10 may hold a management table of nodes participating in a network, including upper nodes thereof, as shown in the following table 2. The GW 10 for example selects a radio wave having a maximum electric field strength, from radio waves received by each node, and defines a node emitting the radio wave having a maximum electric field strength as an upper node of each node. The GW 10 uses the management table to perform dynamic flow control for each node. For example, when movement of a node causes change in electric field strength, the GW 10 changes an upper node in the management table according to the change in electric field strength, and transmits an instruction for changing the upper node to the moved node.

TABLE 2

| Network | |
|---|---|
| participating | |
| node | Upper node |
| Node 11 | GW |
| Node 12 | Node 11 |
| Node 13 | Node 11 |
| Node 14 | Node 13 |

Furthermore, the GW 10 stores bandwidth used for first service (first service bandwidth) and bandwidth used for second service (second service bandwidth) allocated to each of the nodes participating in the network. In addition, the GW 10 stores available bandwidth (physical bandwidth) in the network. In an example illustrated in FIG. 1, packets transmitted from all nodes pass through the node 11, so that the maximum bandwidth of the node 11 represents available physical bandwidth in the network. Note that, when time-division multiplex communication is performed, in a communication control network according to the present exemplary embodiment, “bandwidth” or “band” in description of the present exemplary embodiment can be replaced with “transmission time”.

The first service is high-priority service such as AMI service. In the AMI service, for example communication of electric, gas, or water meter reading is performed. Alternatively, the first service may be for example service used by a vehicle-mounted information terminal. In this configuration, downlink information is traffic jam information, and uplink information is positional information, in the first service. Furthermore, the first service bandwidth is predetermined fixed bandwidth, including a band for multihop construction and a band for controlling quality of service (QoS). That is, a first service band is expressed by the following formula (1).

Fixed band (first service band)=band for meter reading transmission+band for multihop construction+band for controlling QoS . . . (1)

The second service is service having priority lower than that of the first service, including additional service such as video or music distribution or Internet browsing. The second service bandwidth is equal to or larger than guaranteed service bandwidth specified in a contract. In the present exemplary embodiment, all nodes have equal guaranteed service bandwidth, but the guaranteed service bandwidth may differ depending on contracts.

The nodes 11 to 14 are communication devices capable of performing multihop wireless communication. The nodes 11 to 14 are for example wireless local area network (LAN) routers or information collection devices for home energy management system (HEMS). In an example illustrated in FIG. 1, the node 11 is arranged at a position where the node 11 can wirelessly communicates with the GW 10, the node 12, and the node 13. The node 13 is arranged at a position where the node 13 can wirelessly communicates with the node 14.

Furthermore, when the first service is the AMI service, the nodes 11 to 14 are for example smart meters, and the GW 10 is for example a concentrator. In this case, the nodes 11 to 14 transmit data (e.g., electric meter reading) to the GW 10 at predetermined time intervals. The GW 10 collects the data from the nodes 11 to 14, and transmits the data to a meter data management system (MDMS).

Next, allocation of a transmission time to each service will be described, on condition that time-division multiplex communication is used in the network. The GW 10 subtracts, from a frame period, a total one frame transmission time (hereinafter, referred to as first service transmission time) allocated to respective nodes and used for the first service. Then, the GW 10 allocates the obtained time to each node, as one frame transmission time used for second service (hereinafter, referred to as second service transmission time). A time allocated to second service is at least not less than a predetermined guaranteed transmission time, and is fairly allocated to respective nodes. Alternatively, the GW 10 may determine the time allocated to the second service according to a contract previously determined for each node and allocate different times to respective nodes.

Furthermore, the GW 10 determines whether to allow participation of a node requesting participation in the network anew, based on the frame period in the network, the first service transmission time, and a guaranteed one frame transmission time used for the second service (hereinafter, referred to as guaranteed second service transmission time).

Specifically, the GW 10 determines whether to allow participation of the node in the network by control called call admission control (CAC). When all nodes have an equal first service transmission time and an equal guaranteed second service transmission time, the maximum participating number of nodes allowed to participate in the network is determined by the following formula (2).

Maximum participating number of nodes=frame period÷(first service transmission time per node+guaranteed second service transmission time per node) . . . (2)

Furthermore, when respective nodes have different first service transmission times and different guaranteed second service transmission times, the GW 10 confirms whether a new node participating in the network satisfies the following formula (3). Upon participation of the new node satisfying the formula (3), the GW 10 allows participation of the new node, and upon participation of the new node not satisfying the formula (3), the GW 10 refuses participation of the new node.

Frame period>Σ (first service transmission time per node)+Σ(guaranteed second service transmission time per node) . . . (3)

The communication control system according to the present exemplary embodiment preferentially allocates a band to service having high importance, in a network in which multihop communication is performed, and thus insufficient communication band (transmission time) for transmitting high-priority data can be prevented. In particular, nodes are often moved in a multihop communication network, but, according to the communication control system of the present exemplary embodiment, participation of a new node in a network does not interrupt communication of already participating nodes. Furthermore, the communication control system according to the present exemplary embodiment secures a predetermined guaranteed band also for the low-priority service, and service outage can be avoided.

Next, description will be made of operation of the communication control system according to the present exemplary embodiment, upon separation of some of the nodes from a network. FIG. 2 is a flowchart illustrating operation which is performed when some of the nodes are separated from the network. FIG. 3 is an explanatory diagram illustrating a state of the network from which the some of the nodes are separated.

Respective nodes periodically confirm connection of lower nodes. For the connection confirmation, for example, beacon is used which is used for general wireless communication devices. Furthermore, for a band used for the connection confirmation, the band for multihop construction of the first service band is used. In an example illustrated in FIG. 2, the node 11 failing to receive a radio wave from the node 12 determines (detects) that the node 12 is separated from the network (step S1-1). The node 13 failing to receive a radio wave from the node 14 determines (detects) that the node 14 is separated from the network (step S1-2). Failure in reception of radio wave between a node and another node is caused by for example failure in wireless communication caused by power failure, device failure, or movement of the node. Note that, the order of steps S1-1 and S1-2 may be reversed.

Next, the node 11 transmits notification of separation of the node 12 from the network, to the GW 10 (step S2-1). The node 13 transmits notification of separation of the node 14 from the network, to the GW 10 through the node 11 (step S2-2). Note that, the order of steps S2-1 and S2-2 may be reversed.

The GW 10 receives the notification of separation of the nodes 12 and 14 from the network, and recalculates the band where the nodes 12 an 14 are removed from the management table (step S3). Next, the GW 10 removes the nodes 12 and 14 from the management table, and performs flow control to the nodes based on recalculated flow (step S4). Note that, after removal of the nodes 12 and 14 from the management table, the GW 10 may recalculate the band based on the management table. Specifically, the GW 10 removes the nodes 12 and 14 from the management table shown in table 1, and updates the management table to a management table shown in Table 3.

TABLE 3
Network participating node
Node 11
Node 13

The flow control in step S4 will be described in detail, on condition that time-division multiplex communication is used in the network. Since the first service band is the fixed band having a high priority, the GW 10 allocates, as the first service transmission time, a transmission time equal to the transmission time before separation of the nodes 12 and 14, to each of the nodes 11 and 13.

Furthermore, the GW 10 allocates a transmission time determined by the following formula (4), as the second service transmission time, to each of the nodes 11 and 13. The participating number of nodes represents the number of nodes included in the updated management table.

Second service transmission time=(frame period−first service transmission time×participating number of nodes)÷participating number of nodes . . . (4)

FIG. 4 is an explanatory diagram illustrating a state of the network after performance of flow control based on recalculated bandwidth. After the recalculation, the GW 10 transmits, to each node, notification of one frame transmission time allocated and transmission timing in the frame. Each node performs communication based on the notification of transmission time and the transmission timing. As exemplified in FIG. 4, available second service bandwidth (transmission time) for the nodes 11 and 13 increases compared with that before separation of the nodes 12 and 14.

Next, description will be made of operation performed when communication with the nodes 12 and 14 succeeds again owing to power recovery or the like, and the nodes 12 and 14 request participation in the network. FIG. 5 is a flowchart illustrating operation which is performed when the separated nodes request participation in the network again. FIG. 6 is an explanatory diagram illustrating a state of the network where the second service band is returned to the previous band.

After communicate with the node 11 succeeds, the node 12 transmits a request to the node 11 for participation in the network (step S11-1). After communicate with the node 13 succeeds, the node 14 transmits a request to the node 13 for participation in the network (step S11-2). Success communication between a node and another node is caused by for example success wireless communication caused by power recovery, recovery from device failure, or movement of the node. Note that, the order of steps S11-1 and S11-2 may be reversed.

When receiving the participation request from the node 12, the node 11 transmits notification of the received contents, to the GW 10 (step S12-1). When receiving the participation request from the node 14, the node 13 transmits notification of the received contents to the GW 10 through the node 11 (step S12-2).

Next, when receiving the participation request from the nodes 12 and 14, from the nodes 11 and 13, the GW 10 recalculates the band where the nodes 12 and 14 are added to the management table (step S13). Specifically, the GW 10 calculates formula (2) or (3), including the nodes 12 and 14, and determines whether participation of the nodes 12 and 14 is allowed. When participation of the nodes 12 and 14 is allowed, the GW 10 updates the participating number of nodes to a number including the nodes 12 and 14, and recalculates formula (4). When the participation is allowed based on the calculation of formula (2) or (3), the GW 10 then adds the nodes 12 and 14 to the management table (step S14). Note that, after addition of the nodes 12 and 14 to the management table, the GW 10 may recalculate the band based on the management table.

The GW 10 performs flow control to the nodes 11 to 14 based on recalculated flow (step S15). Specifically, the GW 10 returns the second service bandwidths of the nodes 11 and 13 to the bandwidths before separation of the nodes 12 and 14 from the network, according to a result of calculation, and then allocates a band to each of the nodes 12 and 14. Bandwidths illustrated in FIG. 6 show a state after the GW 10 returns the second service bandwidths of the nodes 1 and 13. Note that, for example, owing to participation of a new node other than the nodes 11 to 14 in the network, the bandwidth of each node may not be returned to the bandwidth before separation of the nodes 12 and 14.

The communication control system according to the present exemplary embodiment recalculates an unoccupied band to update the management table, when some of the nodes are separated from the network due to power failure or the like, in the network in which multihop communication is performed. Thus, the communication control system can effectively use the band dynamically, and increase user's convenience. Furthermore, when the some of the nodes participate in the network again, the communication control system recalculates the unoccupied band to dynamically secure the band fairly for the nodes participating in the network again and the already participating nodes.

### Exemplary Embodiment 2

Next, description will be made of an example in which when a node fails to communicate with an upper node due to power failure or the like, the node communicates with a node belonging to another network. FIG. 7 is an explanatory diagram illustrating a configuration of a communication control system according to a second exemplary embodiment (Exemplary embodiment 2). In the communication control system of FIG. 7, GWS and nodes have functions similar to the functions of the GW and the nodes of the first exemplary embodiment, unless otherwise described.

As illustrated in FIG. 7, the communication control system according to the present exemplary embodiment includes a GW 10, nodes 11 and 12 controlled by the GW 10, a GW 20, and nodes 21 and 22 controlled by the GW 20. The GW 10 can only communicate with the node 11. The GW 20 can only communicate with the node 21. Communication between the nodes 11 and 12 and the nodes 21 and 22 uses multihop communication. Furthermore, the node 12 is located at a position where communication can be performed with the node 21.

Next, operation performed upon communication failure of a node with an upper node will be described. FIG. 8 is a flowchart illustrating operation of the communication control system according to the second exemplary embodiment.

Let us assume that while the node 12 communicates with the node 11, the node 12 fails to communicate with the node 11, due to power failure at an installation position of the node 11, failure of the node 11, movement of the node 11 or 12, or the like (step S21). Since the node 12 is positioned at a distance where communication can be performed with the node 21, the node 12 transmits a requests to the GW 20 for participation in a network, through the node 21 (step S22), and when the participation is allowed, communication with the node 21 is started (step S23).

FIG. 9 is an explanatory diagram illustrating a state of networks in which any of the nodes participates in another network. The GW 20 uses formula (2) or (3) to determine whether to allow participation of the node in the network, as described in the first exemplary embodiment. Furthermore, the GW 20 uses formula (4) to calculate the second service bandwidth, as described in the first exemplary embodiment. As illustrated in FIG. 9, participation of the node 12 in the network controlled by the GW 20 causes reduction of the second service bandwidth of the node 12, and the nodes 21 and 22, compared with that illustrated in FIG. 7.

Next, when communication of the node 11 succeeds owing to power recovery or the like, the node 12 for example receives beacon from the node 11, and recognizes success of communication with the node 11 (step S24). FIG. 10 is an explanatory diagram illustrating a state of networks when the separated node is returned. Since there are at least two networks communicable with the node 12, the node 12 makes inquiries to the GWS 10 and 20 for unoccupied bandwidths of the networks (step S25).

When receiving the inquiries from the node 12, the GWS 10 and 20 each transmit notification of the unoccupied bandwidth to the node 12 (step S26). Specifically, when time-division multiplex communication is used in the network, the GWS 10 and 20 each calculate an unused transmission time based on the following formula (5), and transmit notification of the unused transmission time to the node 12. Note that, in formula (5), the unused transmission time, a first service transmission time, and a guaranteed second service transmission time are a one frame transmission time.

Unused transmission time =frame period—(first service transmission time per node+guaranteed second service transmission time per node)×participating number of nodes . . . (5)

Furthermore, when the nodes have different first service transmission times and different guaranteed second service transmission times, the GWS 10 and 20 use the following formula (6) to calculate the unused transmission time.

Unused transmission time =frame period—(Σ(first service transmission time per node)+Σ(guaranteed second service transmission time per node)) . . . (6)

The node 12 determines a network to which a participation request is made, based on the notifications of the unused transmission times from the GWS 10 and 20. In each of formulas (5) and (6), the transmission time used by the node 12 itself is included. Therefore, for example, when a time obtained by subtracting the unused transmission time of the GW 20 from the unused transmission time of the GW 10 is not less than a predetermined time, the node 12 transmits the participation request to the GW 10. This predetermined time is, for example, expressed by formula: first service transmission time of the node 12+guaranteed second service transmission time.

In an example illustrated in FIG. 10, since the network controlled by the GW 10 has a larger unused transmission time, so that the node 12 transmits, to the GW 10, notification of the participation request, and starts communication with the node 11 again (step S27). Then, the GWS 10 and 20 recalculate flow, and update the management table to return the state of the network to the state illustrated in FIG. 7. That is, the node 12, and the nodes 21 and 22 have a large second service bandwidth. Note that, the GWS 10 and 20 may recalculate flow based on a management table having been updated.

Note that, in the present exemplary embodiment, an example of participation, in another network, of a node failing to communicate with an upper node has been described. However, a node capable of communicating with an upper node may transmit a participation request to another network having a larger unused transmission time.

According to the communication control system of the present exemplary embodiment, a node failing to communicate with an upper node can communicate with a node belonging to another network, and service can be continued. Furthermore, according to the communication control system of the present exemplary embodiment, a node capable of participating in a plurality of networks participates in a network having a larger unused transmission time, and bands are effectively used to maintain fairness for each node.

Next, summary of the present invention will be described. FIG. 11 is a block diagram illustrating a configuration of a main portion of the communication control system according to the present invention. The communication control system according to the present invention includes, as a main configuration, a plurality of nodes 31, and a master device 30 for performing flow control of multihop communication in a network including the plurality of nodes 31. The master device 30 allocates, to each of the nodes, a time obtained by subtracting, from a frame period, a total one frame transmission time of each node, used for first service, as a one frame transmission time used for second service having a priority set lower than that of the first service.

In addition, a node according to the following (1) to (10), and a communication control system according to (11) to (13) are also disclosed, in the above-mentioned exemplary embodiments.

(1) A node is included in a communication control system which comprises a plurality of nodes (e.g., nodes 11 to 14) and a master device (e.g., GW 10 or GW 20) for performing flow control of multihop communication in a network including the nodes. To the node, a time obtained by subtracting, from a frame period, a total one frame transmission time of each node, used for first service is allocated, as a one frame transmission time used for second service having a priority set lower than that of the first service.

(2) The node may be configured so that when the node requests participation in the network anew, whether to allow the participation is determined, based on the frame period, a one frame transmission time used for first service, and a guaranteed one frame transmission time used for second service. According to such a node, participation of a new node in the network does not interrupt communication of already participating nodes.

(3) The node may be configured to be operated by flow control using a management table recording nodes participating in the network, participating nodes separated from the network are removed from the management table, and the remaining nodes are operated by flow control to the nodes based on the management table after removal. According to such a node, a band can be effectively used dynamically, and user's convenience can be increased.

(4) The node may be configured to transmit, to the master device, notification of separation of a lower node, upon detection of the separation of the lower node from the network.

(5) The node may be configured so that when a failure occurs to receive a radio wave from the lower node, the node determines that the lower node is separated from the network. According to such a node, separation of a node from the network is automatically determined.

(6) A node may be configured so that when there is no node or master device communicable with the node in the network to which the node belongs, the node transmits a participation request to another network communicable with the node. According to such a node, even if there is no node or master device communicable with the node in the network to which the node belongs, service can be continued.

(7) The node may be configured so that when there is a plurality of networks communicable with the node, the node makes an inquiry to each of master devices controlling the networks, for an unused transmission time of a frame in the network, and determines a network to which a participation request is made, based on the unused transmission times. According to such a node, bands can be effectively used, and fairness for each node can be maintained.

(8) The node may be configured to transmit the participation request to a network having an unused transmission time not less than a predetermined time. According to such a node, participation of the node in another network increases an unused transmission time of an original network in which the node having participated, and the node can be prevented from immediately returning to the original network.

(9) The node may be configured so that the predetermined time is the total of one frame transmission time used for first service and guaranteed one frame transmission time used for second service for the node.

(10) The node may be configured so that a time allocated to second service is determined according to a contract previously determined for each node. According to such a node, a node user can change a band used for additional service, if needed, and user's convenience is increased.

(11) A communication control system includes a plurality of nodes (e.g., nodes 11 to 14), and a master device (e.g., GW 10 or GW 20) for performing flow control of multihop communication in a network including the nodes. The master device allocates, to each of the nodes, a time obtained by subtracting, from a frame period, a total one frame transmission time of each node, used for first service, as a one frame transmission time used for second service having a priority set lower than that of the first service.

(12) The communication control system may be configured so that the master device determines whether to allow participation of a node requesting participation in the network anew, based on the frame period, a one frame transmission time used for first service, and a guaranteed one frame transmission time used for second service. According to such a communication control system, participation of a new node in the network does not interrupt communication of already participating nodes.

(13) The communication control system may be configured so that the master device performs flow control using a management table recording nodes participating in the network, removes, from the management table, participating nodes separated from the network, and performs flow control to each nodes based on the management table after removal. According to such a communication control system, a band can be effectively used dynamically, and user's convenience can be increased.

Furthermore, the node according to the above-mentioned (1) to (10), and the communication control system according to (11) to (13) are also described as a node according to the following (1A) to (10A) and a communication control system according to (11A) to (13A). FIG. 12 is a block diagram illustrating a specific configuration of the main portion of the communication control system according to the present invention. The following node and communication control system have means which are respectively achieved by hardware designed to perform specific calculation processing or the like, or a computer operated according to a program. Furthermore, the program is stored in a non-transitory computer-readable storage medium.

(1A) A node is included in a communication control system which comprises a plurality of nodes (e.g., nodes 31 and 32 or nodes 11 to 14) and a master device (e.g., master device 30, GW 10 or GW 20) for performing flow control of multihop communication in a network including the nodes. To the node, a time obtained by subtracting, from a frame period, a total one frame transmission time of each node, used for first service is allocated, as a one frame transmission time used for second service having a priority set lower than that of the first service, by allocation means (e.g., allocation means 32).

(2A) The node may be configured so that when the node requests participation in the network anew, whether to allow the participation is determined by determination means (e.g., determination means 33), based on the frame period, a one frame transmission time used for first service, and a guaranteed one frame transmission time used for second service. According to such a node, participation of a new node in the network does not interrupt communication of already participating nodes.

(3A) The node may be configured to be operated by flow control performed by control means (e.g., control means 34), using a management table recording nodes participating in the network, participating nodes separated from the network are removed from the management table, and the remaining nodes are operated by flow control to the nodes by the control means, based on the management table after removal. According to such a node, a band can be effectively used dynamically, and user's convenience can be increased.

(4A) The node may be configured to include notification means (e.g., notification means 35) for transmitting, to the master device, notification of separation of a lower node, upon detection of the separation of the lower node from the network.

(5A) The node may be configured to include separation determination means (e.g., separation determination means 36) for determining that the lower node is separated from the network, when a failure occurs to receive a radio wave from the lower node. According to such a node, separation of a node from a network is automatically determined

(6A) A node may be configured to include participation request means (e.g., participation request means 37) for transmitting a participation request to another network communicable with the node, when there is no node or master device communicable with the node in the network to which the node belongs. According to such a node, even if there is no node or master device communicable with the node in a network to which the node belongs, service can be continued.

(7A) The node may be configured to include participation network determination means (e.g., participation network determination means 38) for making an inquiry to each of master devices controlling the networks, for an unused transmission time of a frame in the network, and determining a network to which a participation request is made, based on the unused transmission times, when there is a plurality of networks communicable with the node. According to such a node, bands can be effectively used, and fairness for each node can be maintained.

(8A) The node may be configured to include participation request means (e.g., participation request means 37) for transmitting the participation request to a network having an unused transmission time not less than a predetermined time. According to such a node, participation of the node in another network increases an unused transmission time of an original network in which the node having participated, and the node can be prevented from immediately returning to the original network.

(9A) The node may be configured so that the predetermined time is the total of one frame transmission time used for first service and guaranteed one frame transmission time used for second service for the node.

(10A) The node may be configured so that a time allocated to second service is determined by allocation means (e.g., allocation means 32), according to a contract previously determined for each node. According to such a node, a node user can change a band used for additional service, if needed, and user's convenience is increased.

(11A) A communication control system includes a plurality of nodes (e.g., nodes 11 to 14), and a master device (e.g., GW 10 or GW 20) for performing flow control of multihop communication in a network including the nodes. The master device includes allocation means (e.g., allocation means 32) for allocating, to each of the nodes, a time obtained by subtracting, from a frame period, a total one frame transmission time of each node, used for first service, as a one frame transmission time used for second service having a priority set lower than that of the first service.

(12A) The communication control system may be configured so that a master device includes determination means (e.g., determination means 33) for determining whether to allow participation of a node requesting participation in the network anew, based on the frame period, a one frame transmission time used for first service, and a guaranteed one frame transmission time used for second service. According to such a communication control system, participation of a new node in a network does not interrupt communication of already participating nodes.

(13A) The communication control system may be configured so that a master device includes control means (e.g., control means 34) for performing flow control using a management table recording nodes participating in the network, removing, from the management table, participating nodes separated from the network, and performing flow control to each nodes based on the management table after removal. According to such a communication control system, a band can be effectively used dynamically, and user's convenience can be increased.

As described above, the present invention has been described with reference to the exemplary embodiments, but it should be understood that the present invention is not limited to the above-mentioned exemplary embodiments. Various changes and modifications which can be understood by a person skilled in the art may be made to the configurations and details of the present invention within the scope of the present invention.

The present application is based on and claims the benefit of priority from Japanese Patent Application No. 2014-95960 filed on May 7, 2014, the disclosure of which is incorporated herein in its entirety by reference.

### Reference Signs List

10, 20 GW
11 to 14, 21, 22, 31 Node
30 Master device
32 Allocation means
33 Determination means
34 Control means
35 Notification means
36 Separation determination means
37 Participation request means
38 Participation network determination means

1. A node included in a communication control system which comprises a plurality of nodes and a master device for performing flow control of multihop communication in a network including the nodes,
a time being obtained by subtracting, from a frame period, a total one frame transmission time of each node, used for first service, the obtained time being allocated to the node as a one frame transmission time used for second service having a priority set lower than that of the first service.

2. The node according to claim 1, wherein
when the node requests participation in the network anew, whether to allow the participation is determined, based on the frame period, a one frame transmission time used for first service, and a guaranteed one frame transmission time used for second service.

3. The node according to claim 1, wherein
the node is operated by flow control using a management table recording nodes participating in the network, participating nodes separated from the network are removed from the management table, and the remaining nodes are operated by flow control based on the management table after removal.

4. The node according to claim 3, wherein
the node transmits, to the master device, notification of separation of a lower node, upon detection of the separation of the lower node from the network.

5. The node according to claim 4, wherein
when a failure occurs to receive a radio wave from the lower node, the node determines that the lower node is separated from the network.

6. The node according to claim 1, wherein
when there is no node or master device communicable with the node in the network to which the node belongs, the node transmits a participation request to another network communicable with the node.

7. The node according to claim 1, wherein
when there is a plurality of networks communicable with the node, the node makes an inquiry to each of master devices controlling the networks, for an unused transmission time of a frame in the network, and determines a network to which a participation request is made, based on the unused transmission times.

8. The node according to claim 7, wherein
the node transmits the participation request to a network having an unused transmission time not less than a predetermined time.

9. The node according to claim 8, wherein
the predetermined time is the total of one frame transmission time used for first service and guaranteed one frame transmission time used for second service for the node.

10. The node according to claim 1, wherein
a time allocated to second service is determined according to a contract previously determined for each node.

11. A master device for performing flow control of multihop communication in a network including a plurality of nodes,
the master device allocating, to each of the nodes, a time obtained by subtracting, from a frame period, a total one frame transmission time of each node, used for first service, as a one frame transmission time used for second service having a priority set lower than that of the first service.

12. The master device according to claim 11, wherein
the master device determines whether to allow participation of a node requesting participation in the network anew, based on the frame period, a one frame transmission time used for first service, and a guaranteed one frame transmission time used for second service.

13. The master device according to claim 11, wherein
the master device performs flow control using a management table recording nodes participating in the network, removes, from the management table, participating nodes separated from the network, and performs flow control to each node based on the management table after removal.

14. The master device according to claim 11, wherein
the master device determines a time allocated to second service, according to a contract previously determined for each node.

15. A communication control system comprising;
a plurality of nodes; and
a master device for performing flow control of multihop communication in a network including the nodes,
the master device allocating, to each of the nodes, a time obtained by subtracting, from a frame period, a total one frame transmission time of each node, used for first service, as a one frame transmission time used for second service having a priority set lower than that of the first service.

16. The communication control system according to claim 15, wherein
the master device determines whether to allow participation of a node requesting participation in the network anew, based on the frame period, a one frame transmission time used for first service, and a guaranteed one frame transmission time used for second service.

17. The communication control system according to claim 15, wherein
the master device performs flow control using a management table recording nodes participating in the network, removes, from the management table, participating nodes separated from the network, and performs flow control to each node based on the management table after removal.

18. A communication control method used for a plurality of nodes, and a master device for performing flow control of multihop communication in a network including the nodes, the method comprising
causing the master device to allocate, to each of the nodes, a time obtained by subtracting, from a frame period, a total one frame transmission time of each node, used for first service, as a one frame transmission time used for second service having a priority set lower than that of the first service.

19. The communication control method according to claim 18, wherein
the master device determines whether to allow participation of a node requesting participation in the network anew, based on the frame period, a one frame transmission time used for first service, and a guaranteed one frame transmission time used for second service.

20. The communication control method according to claim 18, wherein
the master device performs flow control using a management table recording nodes participating in the network, removes, from the management table, participating nodes separated from the network, and performs flow control to each node based on the management table after removal.

21. The communication control method according to claim 20, wherein
a node transmits, to the master device, notification of separation of a lower node, upon detection of the separation of the lower node from the network.

22. The communication control method according to claim 21, wherein
when a failure occurs to receive a radio wave from a lower node, the node determines that the lower node is separated from the network.

23. The communication control method according to claim 18, wherein
when there is no node or master device communicable with the node in the network to which the node belongs, a node transmits a participation request to another network communicable with the node.

24. The communication control method according to claim 18, wherein
when there is a plurality of networks communicable with the node, the node makes an inquiry to each of master devices controlling the networks, for an unused transmission time of a frame in the network, and determines a network to which a participation request is made, based on the unused transmission times.

25. The communication control method according to claim 24, wherein
the node transmits the participation request to a network having an unused transmission time not less than a predetermined time.

26. The communication control method according to claim 25, wherein
the predetermined time is the total of one frame transmission time used for first service and guaranteed one frame transmission time used for second service for the node.

27. The communication control method according to claim 18, wherein
the master device determines a time allocated to second service, according to a contract previously determined for each node.

28. A non-transitory computer readable recording medium in which a communication control program is recorded, the program is installed in a computer for performing flow control of multihop communication in a network including a plurality of nodes,
the program causing the computer to perform processing of
allocation, to each of the nodes, of a time obtained by subtracting, from a frame period, a total one frame transmission time of each node, used for first service, as a one frame transmission time used for second service having a priority set lower than that of the first service.

29. The non-transitory computer readable recording medium in which the communication control program is recorded according to claim 28, wherein
the communication control program causes the computer to perform processing of determining whether to allow participation of a node requesting participation in the network anew, based on the frame period, a one frame transmission time used for first service, and a guaranteed one frame transmission time used for second service.

30. The non-transitory computer readable recording medium in which the communication control program is recorded according to claim 28, wherein
the communication control program causes the computer to perform flow control using a management table recording nodes participating in the network, remove, from the management table, participating nodes separated from the network, and perform flow control to each node based on the management table after removal.

31. The non-transitory computer readable recording medium in which the communication control program is recorded according to claim 28, wherein
the program causes the computer to perform processing of determining a time allocated to second service, according to a contract previously determined for each node.
